(19) United States
(12) Patent Application Publication
(10) Pub. No.: US 2006/0087607 A1
(43) Pub. Date: Apr. 27, 2006

(54) Multi-domain vertical alignment liquid crystal display device

(75) Inventor: Daniel Lee, Gueishan Township (TW)

Correspondence Address: BACON & THOMAS, PLLC, 625 SLATERS LANE, FOURTH FLOOR, ALEXANDRIA, VA, 22314, US

(73) Assignee: Quanta Display Inc., Tao Yuan Shien (TW)

(21) Appl. No.: 11/227,218

(22) Filed: Sep. 16, 2005

(30) Foreign Application Priority Data
Oct. 26, 2004 (TW) 093132414

(51) Int. Cl. G02F 1/1337

(52) U.S. Cl. 349/129

(57) ABSTRACT

A multi-domain vertical alignment liquid crystal display device is disclosed, comprising a first polarizer having a polarizer axis; a second polarizer having a polarizer axis which intersects the polarizer axis of the first polarizer; a first substrate having a plurality of protrusions forming an angle in the range of 0 degree and 10 degrees or 80 degrees and 90 degrees with respect to the polarizer axis of the first polarizer and the polarizer axis of the second polarizer; a second substrate having a plurality of pixel electrodes; and a liquid crystal layer filled between the first substrate and the second substrate. As such, the present invention is capable of reducing light-leakage generated around the protrusions in pixel electrodes and improving the image quality of the liquid crystal display devices.

### BACKGROUND OF THE INVENTION

1. Field of the Invention

The present invention relates to a liquid crystal display device, and more particularly, to a multi-domain vertical alignment liquid crystal display device.

2. Description of Related Art

A conventional liquid crystal display device generally has polarizers 1, 2 to enhance the contrast ratio of a displayed image, in addition to a top substrate 10 and a bottom substrate 20 both of which sandwich liquid crystals 7 (as shown in FIG. 6). As a rule, the polarizers are disposed to have the polarizer axis 11 of the top substrate to be perpendicular to the polarizer axis 21 of the bottom substrate. As such, only polarization light refracted by the liquid crystal molecules 7 can be transmitted to enhance the contrast ratio of the displayed image and improve the quality of the displayed image.

However, when such a conventional construction is applied to a multi-domain vertical alignment liquid crystal display device, as shown in FIG. 1a (a side view) and FIG. 1b (a top view), an interaction between protrusions 3 in the top substrate of the multi-domain vertical alignment liquid crystal display device and the liquid crystal molecules 7 usually causes the liquid crystal display device to result in light-leaking phenomenon where light somewhat leaks along the edge of the protrusions 3 of the top substrate 10. Thus, the display quality and the contrast ratio of an image are lowered. The light-leaking phenomenon occurs because a geometric space formed by the liquid crystal molecules 7 in the vicinity of the protrusions 3 is compressed and distorted so that the longitudinal axis (or longer axis) direction 71 of the liquid crystal molecules tilts in a direction toward the protrusions 3. When the longitudinal axis direction 71 of the liquid crystal molecules directs toward the transmission axis 31 of the polarizer 1 beside the top substrate 10 (that is, the longitudinal axis direction 71 of the liquid crystal molecules and the polarizer axis 11 of the polarizer beside the top substrate 10 forms an angle of 45 degrees), such a tilted direction causes uncontrollable light-leaking in a power-off/black state. Even in a power-on state, the light-leakage caused by the longitudinal axis direction 71 of the liquid crystal molecules will lower the contrast ratio of the image. Thus, the display quality is impaired. To improve the quality or contrast ratio of the displayed image, there is a dire need to control light-leakage caused by the protrusions and the longitudinal axis direction of the liquid crystal molecules, whereby the image quality of the liquid crystal display devices can be improved.

### SUMMARY OF THE INVENTION

The present invention provides a multi-domain vertical alignment liquid crystal display device so as to reduce light-leaking generated in the vicinity of protrusions of pixel electrodes and improve the image quality of the liquid crystal display devices.

A multi-domain vertical alignment liquid crystal display device according to the present invention comprises a first polarizer having a polarizer axis; a second polarizer having a polarizer axis which intersects the polarizer axis of the first polarizer; a first substrate having a plurality of protrusions disposed on a surface of the first substrate with an angle ranging from 0 to 10 degrees or from 80 to 90 degrees with respect to the polarizer axis of the first substrate and the polarizer axis of the second substrate; a second substrate interposed between the first polarizer and the second polarizer, having a plurality of pixel electrodes disposed on a surface of the second substrate; and a liquid crystal layer interposed between the first substrate and the second substrate. Also, the protrusions of the first substrate are disposed between the first substrate and the second substrate.

The surfaces of the pixel electrodes of the liquid crystal display device according to the present invention may selectively further comprise a plurality of slits to improve the uniformity of brightness. The slits are disposed on the edge of the pixel electrodes and extend in a direction to intersect the projections of the protrusions on the second substrate. The intersection angle between the extension from the slits and the projections of the protrusions is not specifically defined to be different from a known angle. Preferably, the angle between the extension from the slits and the projections of the protrusions is in the range of 80 degrees and 110 degrees. The length distribution of the slits is not specifically defined. Preferably, at least two of the slits are different in length, and more preferably, the length of the slits is arranged to be gradually decreased or increased from both ends of the same edge of the pixel electrodes toward the middle of the pixel electrodes. The width distribution of the space or the interval between the slits is not specifically defined. Preferably, the slits have at least two different spaces, and more preferably, the width of the intervals between the slits is arranged to be gradually decreased or increased from both ends of the same edge of the pixel electrodes toward the middle of the pixel electrodes. The intersection angle between the polarizer axis of the second polarizer and the polarizer axis of the first polarizer is not specifically defined to be different from a known angle. Preferably, the polarizer axis of the second polarizer is perpendicular to the polarizer axis of the first polarizer. The angle between the protrusions and the polarizer axis of the first polarizer and the polarizer axis of the second polarizer according to the present invention is not specifically defined to be different from a known angle in the range of 0 degree and 10 degrees or 80 degrees and 90 degrees. Preferably, they are perpendicular to or parallel with each other. The first substrate and the second substrate according to the present invention can be conventional transparent substrate, preferably, glass substrates. The pixel electrodes of the present invention can be a conventional transparent electrode, preferably an indium tin oxide (ITO) or an indium zinc oxide (IZO). The shape of the protrusions distributed on the first substrate is not specifically defined, preferably zigzag. The liquid crystals suitable for the present invention are not specifically defined. Preferably, the liquid crystal molecules are those having negative dielectric anisotropy.

Other objects, advantages, and novel features of the invention will become more apparent from the following detailed description when taken in conjunction with the accompanying drawings.

### BRIEF DESCRIPTION OF THE DRAWINGS

FIG. 1a is a side view of a conventional multi-domain vertical alignment liquid crystal display device.

FIG. 1b is a top view of a conventional multi-domain vertical alignment liquid crystal display device.

FIG. 2a is a side view of a preferred embodiment of the present invention.

FIG. 2b is a top view of a preferred embodiment of the present invention.

FIG. 3a is a top view of a preferred embodiment of the present invention in a black state.

FIG. 3b is a top view of a preferred embodiment of the present invention in a bright state.

FIG. 4 is a top view of another preferred embodiment of the present invention.

FIG. 5 is a top view of a further preferred embodiment of the present invention.

FIG. 6 is a schematic perspective view of a conventional liquid crystal display device.

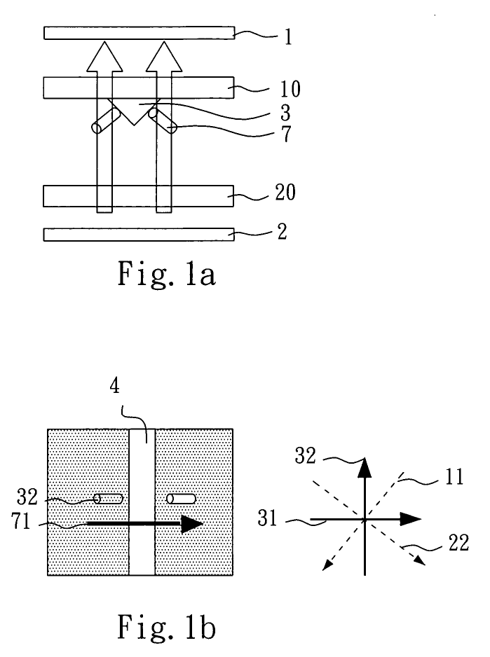

### DETAILED DESCRIPTION OF THE PREFERRED EMBODIMENT

### Embodiment 1

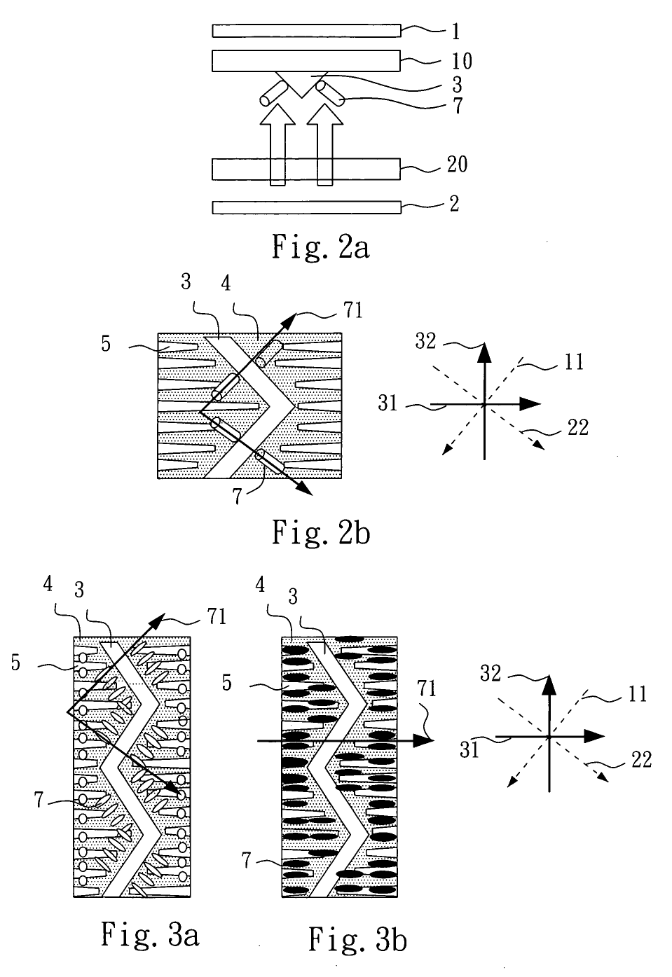

At first, reference is made to both FIG. 2(a), which is a side view of a preferred embodiment according to a multi-domain vertical alignment liquid crystal display device of the present invention, and FIG. 2(b), which is a top view of the present embodiment. As illustrated, the multi-domain vertical alignment liquid crystal display device of the present embodiment comprises an upper polarizer 1, a lower polarizer 2, a top substrate (first substrate) 10, and a bottom substrate (second substrate) 20. In the present embodiment, a liquid crystal layer 7 is filled between the top substrate 10 and the bottom substrate 20 so as to besealed. The upper polarizer 1 and the lower polarizer 2 can be disposed respectively on the surfaces of the upper and the bottom substrates facing to the liquid crystal layer or substrate surfaces outside the liquid crystal layer. In the present embodiment, the upper polarizer 1 and the lower polarizer 2 are disposed on the outside surfaces of the top substrate 10 and the bottom substrate 20, respectively. The polarizer axes of the upper polarizer 1 and the lower polarizer 2 of the present invention respectively are disposed in a crossing manner. In the present embodiment, the polarizer axis 11 (as indicated by the dotted line arrow) of the upper polarizer 1 and the polarizer axis 22 (as indicated by the dotted line arrow) of the lower polarizer 2 are disposed to be perpendicular to each other.

In the present embodiment, multiple protrusions are formed or laid on the top substrate 10 for directing the longitudinal axis direction 71 of the liquid crystal molecules to tilt toward the protrusions 3 by utilizing the change of the space. Generally, the longitudinal axis direction 71 of the liquid crystal molecules is perpendicular to the protrusion 3 as viewed from the top. In the present embodiment, the protrusions 3 are shaped as zigzag. The projections of the zigzag protrusions 3 on the surface of the bottom substrate 20 are parallel with or perpendicular to the polarizer axis 11 of the first polarizer 1 or the polarizer axis 22 of the second polarizer 2. With such an arrangement of the protrusions 3, the longitudinal axis direction 71 of the liquid crystal molecules is perpendicular to the protrusions 3. Thus, the longitudinal axis direction 71 of the liquid crystal molecules is parallel with or perpendicular to the polarizer axis 11 of the first polarizer 1 or the polarizer axis 22 of the second polarizer 2. In other words, the longitudinal axis direction 71 of the liquid crystal molecules and the transmission axis 31 of the first polarizer 1 or the transmission axis 32 of the second polarizer 2 form an angle of about 45 degrees. The light-leaking resulted from the interaction of the liquid crystal molecules 7 and the protrusions 3 can be greatly reduced through the arrangement of the present embodiment. Since the transmission axes 31, 32 are not parallel with the longitudinal axis direction 71 of the liquid crystal molecules in the present embodiment, the light-leaking between the liquid crystal molecules 7 and the protrusions 3 owing to the refraction of the liquid crystal molecules can be significantly reduced.

In the present embodiment, the bottom substrate (second substrate) 20 has a plurality of arrayed pixel electrodes 4. The pixel electrodes 4 are made of ITO in the present embodiment. The pixel electrodes 4 in the vicinity of the bottom substrate (second substrate) 20 are spaced apart, a plurality of slits 5 being formed on the edge of the pixel electrodes 4 spaced apart. In the present embodiment, the slits 5 extend in a direction having a 45-degree angle with respect to the polarizer axes 11, 22 of the polarizers. The slits are different in length.

The slits 5 are disposed on the edge of the pixel electrodes 4, extending in a direction having an intersection angle of about 45 degrees with respect to the projections of the protrusions 3 on the bottom substrate (second substrate) 20. Furthermore, the lengths (L) of the slits 5 are arranged to be gradually decreased or increased from both ends of the same edge of the pixel electrodes 4 to the middle of the pixel electrodes 4. When a voltage is applied to the liquid crystal display device, the negative liquid crystal molecules 7 in a grayscale generally tilt in various tilted angles since the lengths of the slits affect the electric field. In other words, the liquid crystal molecules 7 have various tilted angles in the vicinity of one of the protrusions 3 in a pixel electrode 4. Even so, the tilted angles of the liquid crystal molecules 7 are distributed in a regular manner because the slits are distributed in a regular manner. It has been known that the transmissivity of the liquid crystal display relates to the total average refractive index caused by the tilted angle of the liquid crystal molecules 7. With the arrangement of the slits as disclosed in the present invention, the total average tilted angle of the liquid crystal molecules 7 in the vicinity of the protrusions 3 are about the same. Thus, the total average refractive index caused by the tilted angle of the liquid crystal molecules 7 is almost the same. Hence, the transmittance of the area neighboring to the protrusions 3 is almost the same, too. In this connection, the brightness distribution of the various pixel electrodes 4 in the liquid crystal display device can be improved, resulting in a uniform brightness of the liquid crystal display device. Through the arrangement of the device illustrated above, a stable average angle of the various angles between the sight line of a viewer and the longitudinal axis direction 71 of the liquid crystals in a grayscale can be obtained. When the liquid crystal display device is viewed from different angles, the angle between the sight line and the longitudinal axis direction 71 of the liquid crystals remains as the average value. Therefore, the angle between the sight line and the longitudinal axis direction 71 of the liquid crystals does not vary with a change of the viewing angle. Hence, the liquid crystal display device has a uniform brightness regardless of the viewing angle.

Reference is made to both FIG. 3a and FIG. 3b, in which FIG. 3a is a top view of this preferred embodiment in a black state while FIG. 3b is a top view of this preferred embodiment in a bright state. As described above, in the black state (as a voltage is applied), the tilted arrangement of the protrusions 3 causes the transmission axes 31, 32 to be unparallel with the longitudinal axis direction 71 of the liquid crystal molecules so that light-leaking caused by the liquid crystal molecules 7 can be fully reduced to achieve an excellent black state. In applying a voltage, the longitudinal axis direction 71 of the liquid crystal molecules will turn to be parallel with the transmission axes 31, 32, allowing transmission of light. Furthermore, the tilted angle of the liquid crystal molecules 7 will be affected by the slits 5 on the pixel electrodes 4. Hence, as described above, a stable total average refractive index resulted from longitudinal axis direction 71 of the liquid crystal molecules forms, and uniform brightness can be made.

That is to say, non-uniform brightness caused by light-leaking of the liquid crystal molecules 7 can be improved by arranging the directions of the polarizer axes 11, 22 of the polarizers and the tilted angle of the protrusions 3. In addition, the difference between variant total average refractive indexes resulted from the tilted angles of the homogeneously arranged liquid crystal molecules around the two neighboring areas of the protrusions 3 can be improved. Therefore, the light-leakage and the brightness distribution of conventional multi-domain vertical alignment liquid crystal display devices can be effectively improved. Moreover, the contrast ratio of the displayed image of conventional multi-domain vertical alignment liquid crystal display devices can be increased, and the display quality thereof can be improved.

### Embodiment 2

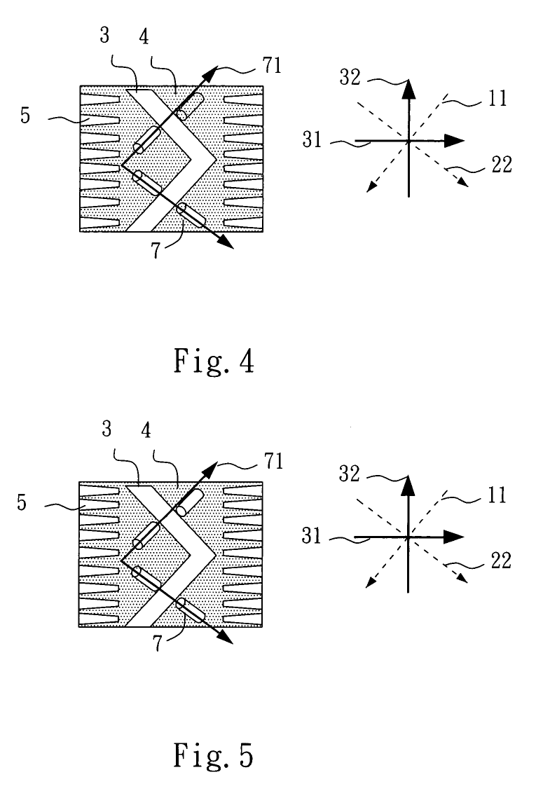

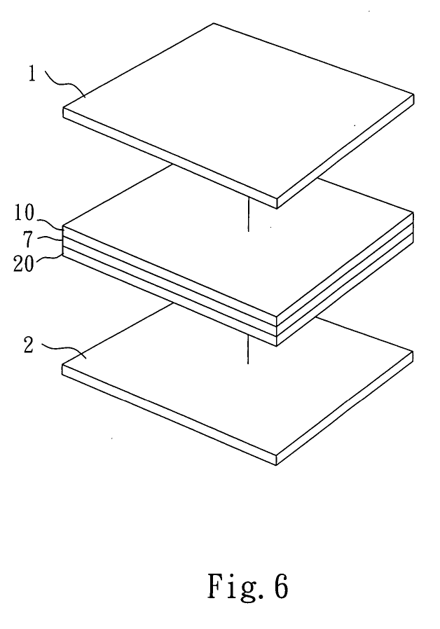

FIG. 4 is a schematic top view of a multi-domain vertical alignment liquid crystal display device according to another preferred embodiment of the present invention. The multi-domain vertical alignment liquid crystal display device of this embodiment is constructed and arranged in the same manner as the aforesaid embodiment, except that the slits 5 are distributed on the multiple arrayed pixel electrodes 4 on the bottom substrate (second substrate) 20. In this embodiment, the slits 5 are disposed on the edge of the pixel electrodes 4, extending in a direction having an intersection angle of about 45 degrees with respect to the projections of the protrusions 3 on the bottom substrate (second substrate) 20 and being spaced apart with a width arranged to be gradually decreased from both ends of the same edge of the pixel electrodes 4 to the middle of the pixel electrodes 4.

This embodiment has the same effects as the aforesaid embodiment. Non-uniform brightness caused by light-leakage of the liquid crystal molecules 7 can be improved by arranging the direction of the polarizer axes 11, 22 of the polarizers and the tilted angle of the protrusions 3. In addition, the difference between variant total average refractive indexes resulted from the tilted angles of the homogeneously arranged liquid crystal molecules around the two neighboring areas of the protrusions 3 can be improved. Therefore, the light-leakage and the brightness distribution of conventional multi-domain vertical alignment liquid crystal display devices can be effectively improved. Moreover, the contrast ratio of the displayed image of conventional multi-domain vertical alignment liquid crystal display devices can be increased, and the display quality thereof can be improved.

### Embodiment 3

FIG. 5 is a schematic top view of a multi-domain vertical alignment liquid crystal display device according to a further preferred embodiment of the present invention. The multi-domain vertical alignment liquid crystal display device of this embodiment is constructed and arranged in the same manner as the aforesaid embodiment, except for slits 5 distributed on the plurality of arrayed pixel electrodes 4 of the bottom substrate (second substrate) 20. In this embodiment, the slits 5 are disposed on the edge of the pixel electrodes 4, extending in a direction having an intersection angle of about 45 degrees with respect to the projections of the protrusions 3 on the bottom substrate (second substrate) 20 and being spaced apart with a width arranged to be gradually increased from both ends of the same edge of the pixel electrodes 4 to the middle of the pixel electrodes 4.

This embodiment has the same effects as the aforesaid embodiment. Non-uniform brightness caused by light-leaking of the liquid crystal molecules 7 can be ameliorated by arranging the direction of the polarizer axes 11, 22 of the polarizers and the tilted angle of the protrusions 3. In addition, the difference between variant total average refractive indexes resulted from the tilted angles of the homogeneously arranged liquid crystal molecules around the two neighboring areas of the protrusions 3 can be improved. Therefore, the light-leakage and the brightness distribution of conventional multi-domain vertical alignment liquid crystal display devices can be effectively improved. Moreover, the contrast ratio of the displayed image of conventional multi-domain vertical alignment liquid crystal display devices can be increased, and the display quality thereof can be improved.

Although the present invention has been explained in relation to its preferred embodiments, it is to be understood that many other possible modifications and variations can be made without departing from the spirit and scope of the invention as hereinafter claimed.

What is claimed is:

1. A multi-domain vertical alignment liquid crystal display device, comprising:
a first polarizer;
a second polarizer having a polarizer axis which intersects a polarizer axis of said first polarizer;
a first substrate disposed between said first polarizer and said second polarizer, having a plurality of protrusions on a surface of said first substrate with an angle ranging from 0 to 10 degrees or from 80 to 90 degrees with respect to said polarizer axis of said first substrate or said polarizer axis of said second substrate;
a second substrate disposed between said first polarizer and said second polarizer, having a plurality of pixel electrodes on a surface of said second substrate; and
a liquid crystal layer filled between said first substrate and said second substrate;
wherein said protrusions are disposed between said first substrate and said second substrate.

2. The device of claim 1, wherein said pixel electrodes further comprise a plurality of slits disposed on the edge of said pixel electrodes, said slits extending in a direction to intersect the projections of said protrusions on said second substrate.

3. The device of claim 2, wherein an intersection angle between said slits and said projections of said protrusions is in the range of 80 degrees and 110 degrees.

4. The device of claim 2, wherein at least two of said slits are different in length.

5. The device of claim 2, wherein lengths of said slits are arranged to be gradually decreased or increased from both ends of the same edge of said pixel electrodes to the middle of said pixel electrodes.

6. The device of claim 2, wherein widths of the intervals between said slits are arranged to be gradually decreased or increased from both ends of the same edge of said pixel electrodes to the middle of said pixel electrodes.

7. The device of claim 1, wherein said first substrate and said second substrate are glass substrates.

8. The device of claim 1, wherein said projections are shaped as zigzag.

9. The device of claim 1, wherein said polarizer axis of said second polarizer is perpendicular to said polarizer axis of said first polarizer.

10. The device of claim 1, wherein said liquid crystal layer comprises liquid crystal molecules having negative dielectric anisotropy.

11. The device of claim 2, wherein at least two intervals between the slits are different.
